(19) United States
(12) Patent Application Publication
(10) Pub. No.: US 2024/0029017 A1
(43) Pub. Date: Jan. 25, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Shinya YAMASAKI, Tokyo (JP)

(73) Assignee: NEC Corporation, Minato-ku, Tokyo (JP)

(21) Appl. No.: 18/021,742

(22) PCT Filed: Sep. 21, 2021
(86) PCT No.: PCT/JP2021/034516

§ 371 Date: Feb. 16, 2023

(30) Foreign Application Priority Data
Sep. 28, 2020 (JP) 2020-161649

(51) Int. Cl. G06Q 10/087

(52) U.S. Cl. CPC G06Q 10/087

(57) ABSTRACT

This information processing device has a determination unit and a generation unit. When a change in the display state of a product on a product shelf is detected, the determination unit determines whether the change in the display state has been made by a store employee. For example, the change in the display state of a product on the product shelf can be detected by a detection unit such as a weight sensor or a distance sensor. In the case of a weight sensor the change in the display state would be a change in the weight of the product shelf. The generation unit generates shelf allocation information when the change in the display state has been made by a store employee.

### TECHNICAL FIELD

The present disclosure relates to an information processing device and the like.

### BACKGROUND ART

There is a technology of creating shelf allocation information about products displayed on a product shelf. For example, in the technology described in PTL 1, shelf allocation information is created based on an image obtained by imaging a plurality of products.

In addition, in the technology described in PTL 2, in a case where products are sold using an unmanned type shelf fixture for sales, the product type and the number of products taken out from a shelf board are specified based on a change in weight detected by a shelf and a captured image.

### CITATION LIST

### Patent Literature

[PTL 1] JP 2020-74228 A
[PTL 2] JP 2019-208627 A

### SUMMARY OF INVENTION

### Technical Problem

However, in the technology described in PTL 1, shelf allocation information may be generated in a state where a product is not displayed on a correct product shelf or at a correct position on the product shelf. Therefore, the technology described in PTL 1 has a problem that accuracy of shelf allocation information may be low.

An object of the present disclosure is to provide an information processing device and the like capable of improving accuracy of shelf allocation information.

### Solution to Problem

According to an aspect of the present disclosure, an information processing device includes: a determination means configured to, when a change in display state of a product on a product shelf is detected, determine whether the change in display state is a change made by a store clerk; and a generation means configured to generate shelf allocation information when the change in display state is a change made by the store clerk.

According to another aspect of the present disclosure, a system includes: a detection means configured to detect a change in display state of a product on a product shelf; a determination means configured to determine whether the change in display state is a change made by a store clerk when the change in display state is detected by the detection means; and a generation means configured to generate shelf allocation information when the change in display state is a change made by the store clerk.

According to another aspect of the present disclosure, a method includes: when a change in display state of a product on a product shelf is detected, determining whether the change in display state is a change made by a store clerk; and when the change in display state is a change made by the store clerk, generating shelf allocation information.

According to another aspect of the present disclosure, a non-transitory recording medium records a program for causing a computer to execute: when a change in display state of a product on a product shelf is detected, determining whether the change in display state is a change made by a store clerk; and when the change in display state is a change made by the store clerk, generating shelf allocation information.

### Advantageous Effects of Invention

According to the present disclosure, it is possible to improve accuracy of shelf allocation information.

### BRIEF DESCRIPTION OF DRAWINGS

FIG. 1 is a block diagram illustrating an example of a configuration of an information processing device according to a first example embodiment.

FIG. 2 is a flowchart illustrating an example of an operation of the information processing device according to the first example embodiment.

FIG. 3 is an explanatory diagram illustrating an example of a configuration of a system according to a second example embodiment.

FIG. 4 is a block diagram illustrating an example of a configuration of the system according to the second example embodiment.

FIG. 5 is an explanatory diagram illustrating an example of a change in display state of a product shelf.

FIG. 6 is a sequence diagram related to an example of an operation of the system according to the second example embodiment.

FIG. 7 is a sequence diagram illustrating an example of determination processing using an image.

FIG. 8 is a sequence diagram illustrating an example of determination processing using a change in weight.

FIG. 9 is a sequence diagram illustrating an example of shelf allocation information generation processing.

FIG. 10 is a block diagram illustrating an example of a configuration of a system according to a third example embodiment.

FIG. 11 is a sequence diagram illustrating an example of shelf allocation information generation processing according to the third example embodiment.

FIG. 12 is a block diagram illustrating an example of a configuration of a system according to a fourth example embodiment.

FIG. 13 is an explanatory diagram illustrating an example of a change in display state of a container.

FIG. 14 illustrates an example of a hardware configuration of a system.

### EXAMPLE EMBODIMENT

Hereinafter, example embodiments of an information processing device, an information processing method, and a program according to the present disclosure will be described in detail with reference to the drawings. The present example embodiment does not limit the technology according to the disclosure.

### First Example Embodiment

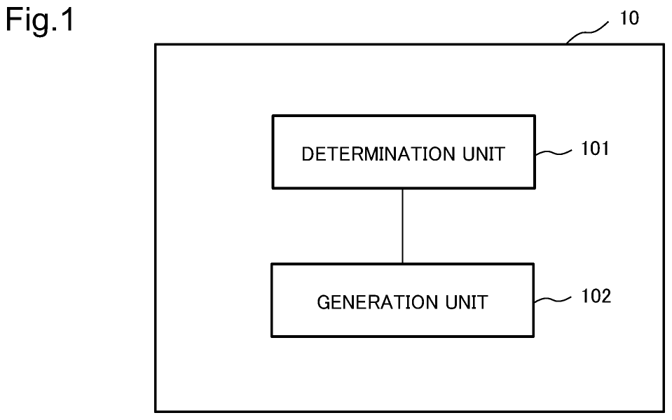

FIG. 1 is a block diagram illustrating an example of a configuration of an information processing device according to a first example embodiment. The information processing device 10 generates shelf allocation information about product shelves used for displaying products in a store. The information processing device 10 can communicate with an imaging device that captures an image used to generate shelf allocation information. Alternatively, the information processing device 10 can access a storage unit that stores an image captured by the imaging device. The type or form of the store is not particularly limited.

The product shelf is, for example, a thing on which products can be displayed. The characteristics of the product shelf, such as a shape, a color, and a material of the product shelf, are not particularly limited. For example, the product shelf may be anything as long as products can be displayed thereon, such as a desk or a container. In addition, the product shelf can detect a change in display state of a product on the product shelf. Then, the information processing device 10 and the product shelf can communicate with each other. When a change in display state is detected by a detection unit, the product shelf notifies the information processing device 10 of the fact. As a result, the information processing device 10 can recognize when the change in display state is detected.

The product shelf includes, for example, a detection unit that detects a change in display state. For example, a specific example of the detection unit may include a weight sensor, a pressure sensor, a distance sensor, or a combination thereof.

For example, the weight sensor detects a change in display state by detecting a change in weight of the product shelf. For example, when a product is newly placed on the product shelf, the weight sensor detects an increase in weight. When a product is removed from the product shelf, the weight sensor detects a decrease in weight. In addition, for example, the weight sensor may also be able to detect an amount of the change in weight such as an increase amount and a decrease amount. For example, when shelf allocation information is generated in a case where a product is newly displayed on the product shelf and an increase in weight is detected, the weight sensor may notify the information processing device 10 of the increase in weight as a change in display state.

For example, the pressure sensor detects a change in display state by detecting a change in pressure of the product shelf. For example, the pressure sensor may detect a change in pressure on a shelf board of the product shelf. Here, the pressure sensor may also be able to detect an amount of the change in pressure. The distance sensor detects a change in display state by detecting a change in distance to a product displayed on the product shelf. For example, when a product is newly placed, the distance sensor can detect a distance between the product and the distance sensor. When a product is removed from the product shelf, the distance sensor is not able to detect a distance between the product and the distance sensor.

In FIG. 1, the information processing device 10 includes a determination unit 101 and a generation unit 102. When a change in display state of a product on the product shelf is detected, the determination unit 101 determines whether the change in display state is a change made by a store clerk. As described above, when the weight sensor is used in the product shelf, the change in display state may be a change in weight. The change in weight may also be an increase in weight.

Specifically, for example, the determination unit 101 receives a notification of a change in display state from the product shelf. Then, for example, the determination unit 101 determines whether the change in display state is a change made by a store clerk. This notification may include, for example, an amount of the change. Various methods can be used as a determination method. The determination method is not particularly limited. Examples of the determination method include a method using an image, a method using a change in weight of the product shelf, and a method using a beacon device or the like. The method using a change in weight of the product shelf is implemented when the weight sensor is installed in the product shelf. Each determination method will be described in detail in a second example embodiment below.

The generation unit 102 generates shelf allocation information when the change in display state is a change made by a store clerk. As a method of generating shelf allocation information, a conventional technology may be used. The method of generating shelf allocation information is not particularly limited. The specific database structure and storage content of the shelf allocation information are also not particularly limited. For example, in the shelf allocation information, a product identifier such as a product name or a product code, a position of a product on the product shelf, a face side of a product, and the like are registered for each product. The position of the product on the product shelf may be indicated by, for example, a stage number or a slot number of a shelf board. For example, the stage number of the shelf board is a number indicating by how many stages the shelf board is away from the top of the product shelf. In addition, the slot number is a number of a position at which a product is placed on a certain shelf board when set to 1, 2, 3, and the like in order from the left side of the shelf board. It is assumed that one product is placed in one slot. For example, in a case where the stage number of the shelf board is 1 and the slot number is 2, this indicates a second leftmost product on an uppermost shelf board of the product shelf. The face side of the product is, for example, an orientation of the product. The face side of the product is, for example, information indicating which side of the product is visible in an image of the product shelf when viewed from the front. Alternatively, the face side of the product is, for example, information indicating whether a surface of the product is visible in an image of the product shelf when viewed from the front. In addition, the number of displayed products or the like may be registered in the shelf allocation information. In addition, a state of a product or the like may be registered in the shelf allocation information. The state of the product may be a content state of the product. Example of the content state of the product include a best-before date of the product, and the like. The state of the product may be an appearance state of the product. Examples of the appearance state of the product include whether a box of the product is crushed, whether the box of the product is dirty, and the like.

For example, the generation unit 102 identifies such information from a captured image. As a result, the generation unit 102 outputs an identification result as shelf allocation information. Here, the image is, for example, an image of the product shelf. The image of the product shelf is, for example, an image from which a display state of the product shelf can be discriminated. Specifically, for example, the image of the product shelf is an image including the entire product shelf when the product shelf is viewed from the front. Note that the image of the product shelf is not particularly limited as long as shelf allocation information can be generated therefrom.

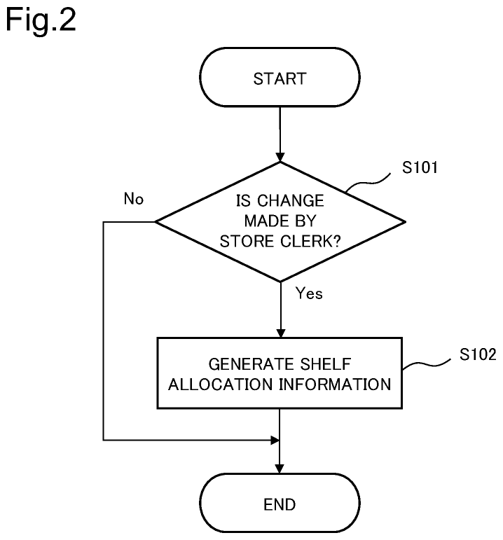

FIG. 2 is a flowchart illustrating an example of an operation of the information processing device 10 according to the first example embodiment. Here, a processing result of each step performed by the information processing device 10 of FIG. 2 is stored in a storage unit that can be accessed by the information processing device 10, such as a storage unit.

First, when a change in display state is detected, the information processing device 10 determines whether the change in display state is a change made by a store clerk (step S101). As described above, the determination method is not particularly limited. When the change in display state is a change made by a store clerk (step S101: Yes), the information processing device 10 generates shelf allocation information (step S102). Then, after the step S102, the information processing device 10 ends the operation of the flow. When the change in display state is not a change made by a store clerk (step S101: No), the information processing device 10 ends the operation of the flow.

Next, an effect of the first example embodiment will be described. The shelf allocation information is used to check a display state, create a shelf allocation proposal, analyze or predict sales analysis, and the like. In particular, in a case where there is no fixed product registration device (register) in a store, it is important to register shelf allocation as to which product is displayed at which position on which product shelf. In a case where the registration of the shelf allocation is manually performed by a store clerk, the store clerk's labor is required. Meanwhile, in a case where shelf allocation information is automatically generated, the shelf allocation information may be generated in a state where a product is not placed at its correct position depending on a generation timing. For example, the display state on the product shelf may be changed by a store clerk or a customer. For example, a store clerk newly displays a product on the product shelf. In addition, a store clerk removes a product from the product shelf. The product to be removed is, for example, a product that has passed the best-before date, a product whose box or the like has been damaged, or the like. On the other hand, a customer takes a product away from the product shelf to purchase the product. Also, a customer takes a product from the product shelf to check the product. In addition, the customer may place back onto the product shelf the product once taken away. However, the customer does not always place the product back to the originally displayed position of the product shelf. In addition, when the customer takes the product away from the product shelf or places the product back onto the product shelf, the display state may be in disorder. As described above, there is a high possibility that shelf allocation information is more accurate in a case where the display state is changed by a store clerk at the time of doing display work than in a case where the display state is changed by a customer. For this reason, the information processing device 10 generates shelf allocation information in a case where the change in display state of the product on the product shelf is a change made by the store clerk. As a result, the information processing device 10 can generate shelf allocation information in a state where the product is more correctly displayed on the product shelf. Therefore, the information processing device 10 can improve accuracy of shelf allocation information.

The change in display state on the product shelf is a change in weight of the product shelf. As a result, the change in display state of the product is accurately detected. Furthermore, the information processing device 10 can improve accuracy of shelf allocation information.

The change in weight is an increase in weight or a decrease in weight. The increase in weight indicates a possibility that a product has been newly displayed. When the increase in weight is detected, the information processing device 10 determines whether the increase in weight is a change made by a store clerk. As a result, when it is estimated that a product has been newly displayed on the product shelf by the store clerk as a result of the determination, the information processing device 10 can generate shelf allocation information.

### Second Example Embodiment

Next, a second example embodiment will be described in detail with reference to the drawings. Hereinafter, description overlapping with what has been described above will be omitted unless the omission obscures the description of the second example embodiment.

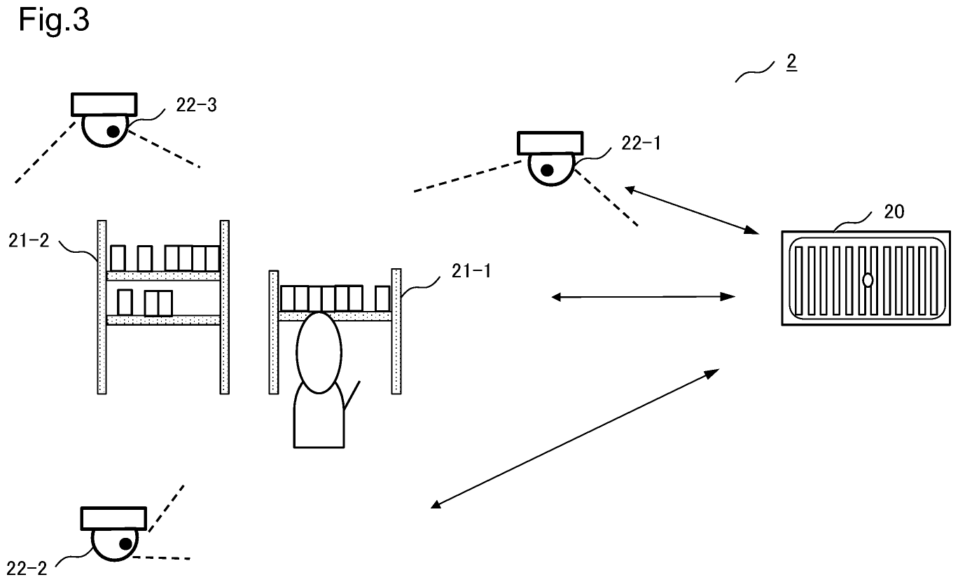

FIG. 3 is an explanatory diagram illustrating an example of a configuration of a system according to the second example embodiment. In FIG. 3, a system 2 includes a product shelf 21, an information processing device 20, and an imaging device 22. Articles are displayed on the product shelf 21. The imaging device 22 is a device capable of capturing an image or a moving image. The information processing device 20 generates shelf allocation information. The product shelf 21, the imaging device 22, and the information processing device 20 can be connected to each other via a communication network or the like.

A plurality of imaging devices 22, such as imaging devices 22-1 to 22-3, may be provided. A plurality of product shelves 21, such as product shelves 21-1 and 21-2, may be provided.

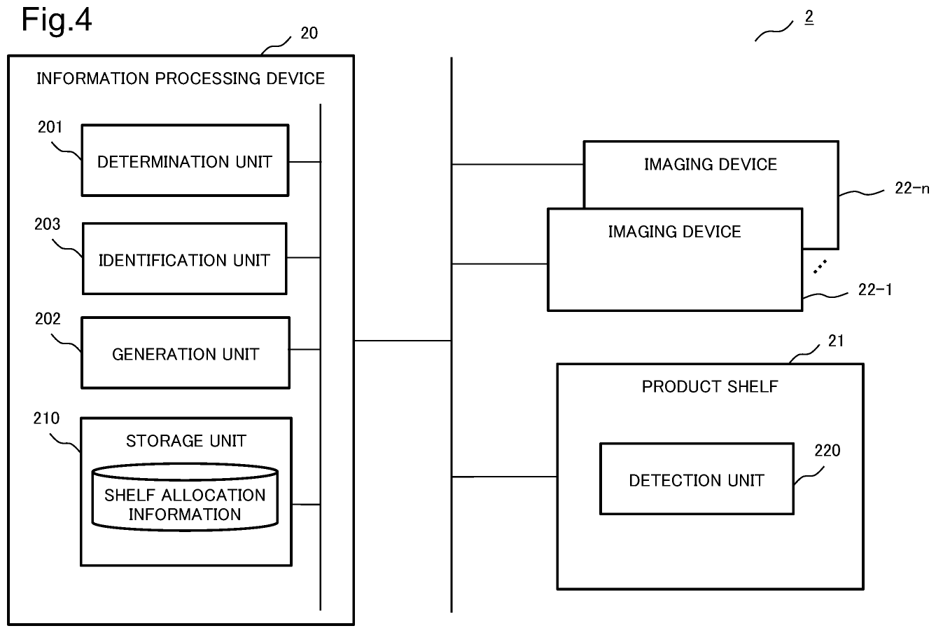

FIG. 4 is a block diagram illustrating an example of a configuration of the system 2 according to the second example embodiment. In FIG. 4, the system 2 includes an information processing device 20, a product shelf 21, and an imaging device 22.

The imaging device 22 captures an image. The product shelf 21 includes a detection unit 220. As described above, the detection unit 220 is a weight sensor, a distance sensor, or a pressure sensor. A plurality of detection units 220 may be provided. In addition, as described above, the detection unit 220 may be, for example, a combination of at least two sensors of the weight sensor, the distance sensor, and the pressure sensor.

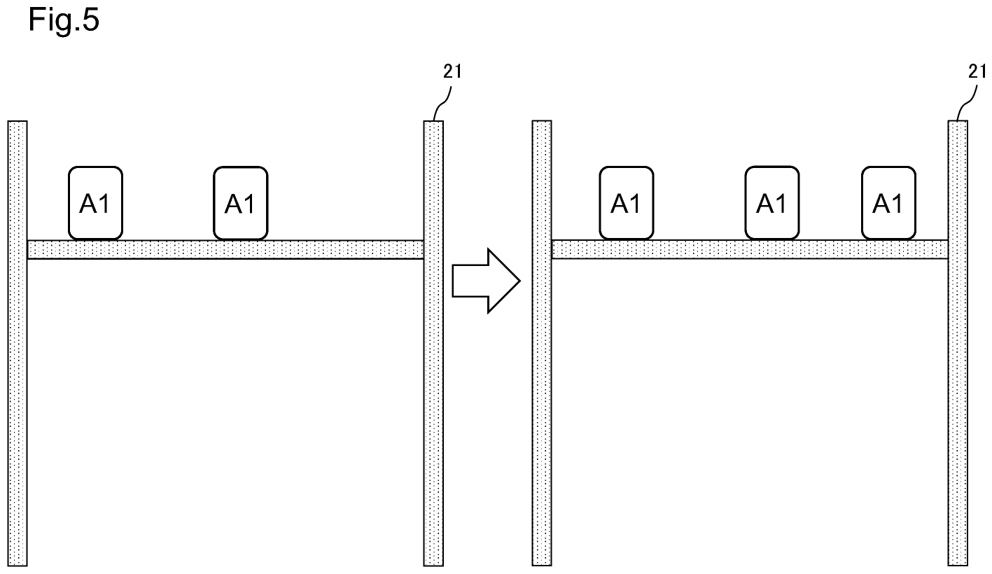

FIG. 5 is an explanatory diagram illustrating an example of a change in display state of the product shelf 21. Two products “A1” are displayed on the product shelf 21. Thereafter, a product “A1” is newly placed on the product shelf 21. Consequently, a total of three products “A1” are displayed on the product shelf 21. For example, the detection unit 220 detects a state where the product “A1” is newly placed on the product shelf 21 as a change in display state. Then, the detection unit 220 notifies the information processing device 20 of the change in display state via the communication network.

For example, when a weight sensor is used as the detection unit 220, the weight sensor detects a change in weight of the product shelf 21. In FIG. 5, an increase in weight for one product “A1” is detected. The detection unit 220 gives a notification of the change in weight via the communication network. In addition, the detection unit 220 may notify the information processing device 20 of an amount of the change in weight together with the change in weight via the communication network. Furthermore, the detection unit 220 may give a notification to which an identifier of the shelf, an identifier of the detection unit 220, or the like is attached. As a result, in a case where there is a plurality of product shelves 21, the information processing device 20 can identify which product shelf 21 has had a change in display state. Furthermore, in a case where a plurality of detection units 220 or a plurality of types of detection units 220 is provided on the product shelf 21, the information processing device 20 can identify which detection unit 220 has detected a change in display state.

In addition, the detection unit 220 may detect an increase in weight or a decrease in weight. The increase in weight indicates a high possibility that a product has been newly displayed. When the increase in weight is detected, the detection unit 220 may notify the information processing device 20 of an amount of the increase together with the increase in weight via the communication network. For example, in FIG. 5, the detection unit 220 detects an increase for a weight of the newly displayed product “A1”. Then, the detection unit 220 notifies the information processing device 20 of the increase in weight and the amount of the increase (for the weight of the product “A1”).

Furthermore, when an increase as much as a predetermined weight (a weight of a product) is detected, the detection unit 220 may notify the information processing device 20 of the increase as much as the weight of the product. Alternatively, the weight sensor may notify the information processing device 20 when an increase as much as a weight based on a weight of a product and a predetermined number is detected. For example, the predetermined number may be set in advance by a store clerk or a user of the information processing device 20. Alternatively, for example, when an amount of an increase in weight exceeds a threshold value, the detection unit 220 may notify the information processing device 20 of the increase in weight.

Returning to the description of FIG. 4, the information processing device 20 includes, for example, a determination unit 201, an identification unit 203, a generation unit 202, and a storage unit 210. When compared to the information processing device 10 according to the first example embodiment, the information processing device 20 according to the second example embodiment additionally includes an identification unit 203 and a storage unit 210. The determination unit 201 has the same function as the determination unit 101 according to the first example embodiment. The generation unit 202 has the same function as the generation unit 102 according to the first example embodiment. First, the storage unit 210 stores a processing result of the information processing device 20 for each function. In addition, the storage unit 210 stores data used for processing of each unit. In FIG. 4, the storage unit 210 stores shelf allocation information as stored content. The content stored in the storage unit 210 in FIG. 4 is an example. For example, the shelf allocation information may be stored in a storage unit of another device such as a storage device connected via the communication network or the like.

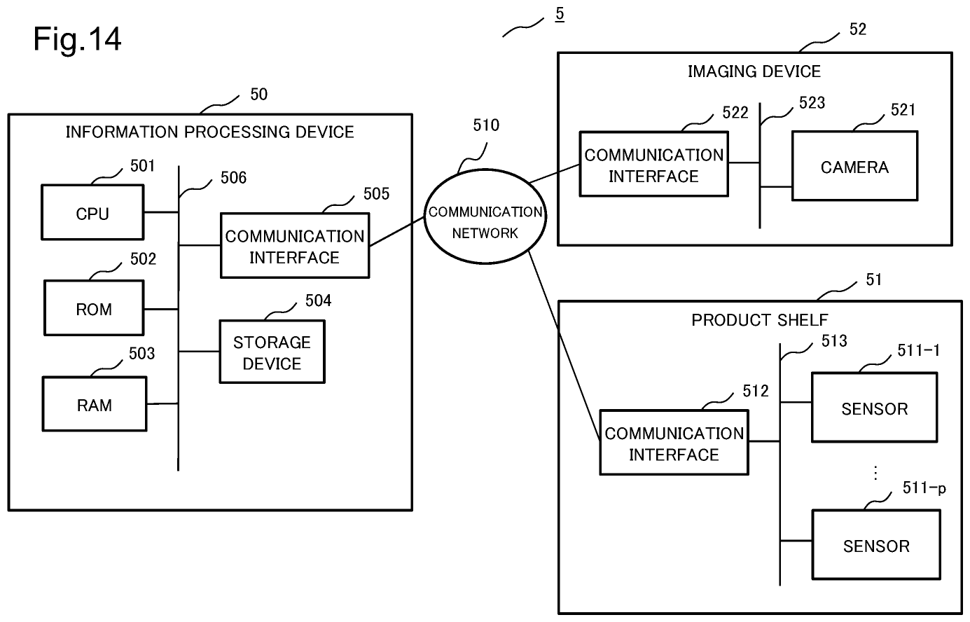

Furthermore, the information processing device 20 needs to be able to access various data. Therefore, similarly to the shelf allocation information, the various data may be stored in a storage device or the like that can be accessed by the information processing device 20 via the communication network. As will be described in detail in an example of a hardware configuration illustrated in FIG. 14, the information processing device 20 loads a program including various instructions for implementing each functional unit into the storage unit 210 to execute the program. Examples of the storage unit 210 include a read only memory (ROM), a random access memory (RAM), a semiconductor memory, a hard disk drive (HDD), a solid state drive (SSD), and the like. Furthermore, the storage unit 210 may be a combination thereof.

When a change in display state on the product shelf 21 is detected, the determination unit 201 determines whether the change in display state is a change made by a store clerk. For example, when shelf allocation information is generated in a case where a product is newly displayed, if the detection unit 220 is a weight sensor, the determination unit 201 may determine whether a change in display state is a change made by a store clerk when an increase in weight of the product shelf 21 is detected. As described in the first example embodiment, when there is a high possibility that a product has been newly displayed on the product shelf as a result of the determination, the information processing device 20 can generate shelf allocation information. Furthermore, when an increase as much as a weight of a product on the product shelf 21 is detected, the determination unit 201 may determine whether the change in display state is a change made by a store clerk. In a case where the detection unit 220 has a weight comparing function, the detection unit 220 may compare an amount of an increase in weight with a weight of a product or the like. Alternatively, the information processing device 20 may determine whether an increase as much as a weight of a product has been detected by comparing an amount of an increase in weight notified from the detection unit 220 with the weight of the product.

As described in the first example embodiment, various methods can be used as a method of determining, by determination unit 201, whether a change is made by a store clerk. The determination method is not particularly limited. Examples of the determination method include a method using an image, a method using a change in weight of the product shelf 21, and a method using a beacon device or the like. The method using a change in weight of the product shelf 21 is performed in a case where a weight sensor is provided on the product shelf 21.

<Determination Method Using Image>

First, a determination method using an image will be described. The determination unit 201 determines that the change in display state is a change made by a store clerk by discriminating the store clerk from the captured image. The image is captured, for example, by the imaging device 22. For example, when a change in display state is detected, an image of the product shelf 21 or the vicinity of the product shelf 21, such as in front of the product shelf 21, is captured by the imaging device 22. Furthermore, the image may be any image as long as a person in the vicinity of the product shelf 21 and a partial portion or an entire portion of the product shelf 21 are imaged. Therefore, the image may be an image used for generating shelf allocation information. A timing at which an image is captured by the imaging device 22 is not particularly limited. For example, the imaging device 22 may capture a moving image at all times. Alternatively, the imaging device 22 may capture an image when an imaging instruction is notified from the information processing device 20. The imaging device 22 stores the captured image in the storage unit 210 or a storage unit 210 that can be accessed by the information processing device 20. Alternatively, the imaging device 22 may transmit the image to the determination unit 201. In addition, the vicinity of the product shelf 21 is, for example, the vicinity of the front side where products can be displayed on the product shelf.

Also, various methods may be used as a determination method using an image. Examples of the determination method using an image include biometric authentication, image matching based on a uniform or the like, movement tracing, and the like. First, the biometric authentication will be described. Here, the biometric authentication is authentication using a biometric feature that can be identified from an image. Examples of the biometric authentication include face authentication. By identifying a face of a person from a captured image, the determination unit 201 determines whether the person is a store clerk. Specifically, for example, face data or the like for a store clerk is stored in advance in the storage unit 210 or the like. Then, determination unit 201 may determine whether the person in the image is a store clerk by matching the face data extracted from the image with the stored face data. When the person in the image is a store clerk, the determination unit 201 determines that the change in display state is a change in display state made by the store clerk.

Next, the image matching based on a uniform or the like will be described. An image matching object may be any one that is carried or worn by a store clerk and can be identified from an image. Examples of the image matching object include a uniform, a name tag, a store clerk's card, and the like. Here, the uniform will be used as an example. The determination unit 201 identifies a uniform from a captured image. If the uniform is identified, the determination unit 201 determines that the change in display state is a change in display state made by the store clerk.

Finally, the movement tracing will be described. When a change in display state is detected from a system (here referred to as the movement trace specifying system) or a device that specifies a movement trace of each person, the determination unit 201 determines whether a person present near the product shelf 21 is a store clerk. Note that the system 2 may have a function of the movement trace specifying system or device that specifies a movement trace of each person. For example, in the movement trace specifying system, for example, an image or a moving image is used to specify a movement trace of each person. In the movement trace specifying system, for example, at an entrance of a store, a mass passing through the entrance is treated as a person. Then, in the movement trace specifying system, when the mass is identified as a store clerk by a store clerk's card or the like, the mass is treated as a store clerk thereafter. Therefore, when a change in display state on the product shelf 21 is detected based on a movement trace of each person, the determination unit 201 determines whether the person in the vicinity of the product shelf 21 is a store clerk. For example, when the person in the vicinity of the product shelf 21 is a store clerk, the determination unit 201 determines that the change in display state is a change in display state made by the store clerk.

<Determination Method Based on Weight>

Next, a method using a change in weight will be described. In this determination method, it is required that a weight sensor be provided on product shelf 21 as the detection unit 220.

The determination unit 201 determines that the change in weight is a change made by a store clerk based on a series of changes in weight of the product shelf 21 within a predetermined period of time from the time when the change in weight of the product shelf 21 is detected. The predetermined period of time is a period of time designated by a store clerk, a user of the information processing device 20, or the like. Alternatively, the predetermined period of time may be a period of time learned from an experience value or the like.

The series of changes in weight are time-series changes in weight. The series of changes in weight may be, for example, time-series shifts in amount of change in weight. From the series of changes in weight, a characteristic pattern is estimated when the changes are made by a store clerk. For example, during display work for taking out a product or the like, a store clerk may remove a product that has passed the best-before date from the product shelf 21, and then display a product that is within the best-before date on the product shelf 21. For example, a case where two products are taken out and three identical products are newly placed within a short period of time (a predetermined period of time) will be described as an example. In this case, as a series of changes in weight, for example, the weight decreases as much as two products and the weight increases as much as three products within the predetermined period of time. Therefore, for example, one or more patterns estimated to be a change in display state made by a store clerk may be prepared in advance. Then, when a series of changes in weight matches the pattern, the determination unit 201 determines that the change in display state is a change made by the store clerk.

Furthermore, the determination unit 201 determines that the change in weight is a change made by a store clerk based on a cumulative amount of changes in weight of the product shelf 21 within a predetermined period of time from the time when the change in weight of the product shelf 21 is detected. For example, during a store clerk's display work for taking out a product or the like, products may be displayed on the product shelf 21 in several units or several tens of units. On the other hand, there is a low possibility that a customer places back a large number of products, such as several tens of products, onto the product shelf 21. Therefore, when the cumulative amount of changes is a predetermined weight, the determination unit 201 determines that the changes in display state are changes in display state made by a store clerk. The predetermined weight may be a weight designated by a store clerk, a user of the information processing device 20, or the like. The predetermined weight may be a multiple of a weight of a product or a weight including an error in the multiple. The multiple of the weight of the product may be obtained, for example, by multiplying the weight of the product and the predetermined number. For example, the predetermined number is a number designated by a store clerk, a user of the information processing device 20, or the like. There may be a plurality of predetermined weights. For example, the plurality of predetermined weights may be prepared when a plurality of predetermined numbers is prepared. In addition, when the cumulative amount of changes is equal to or greater than the predetermined weight, the determination unit 201 may determine that the changes in display state are changes in display state made by a store clerk.

In addition, the determination unit 201 may determine whether the change in weight is a change made by a store clerk depending on whether an amount of the change in weight of the product shelf 21 is within a predetermined range. The predetermined range may be determined by a store clerk or a user of the information processing device 20. The predetermined range may be determined depending on the weight of the product displayed on the product shelf 21. For example, in a case where beverages of cans are displayed individually on the product shelf 21, when an amount of change in weight is out of a range estimated as a weight of one can, there is a high possibility that a product is incorrectly displayed. For example, in a case where an amount of change in weight of the product shelf 21 on which cans of about 350 ml to 500 ml are displayed is 5 kilograms, there is a high possibility that a customer has incorrectly placed a product on the product shelf 21. Therefore, when the amount of change in weight of the product shelf 21 is not within the predetermined range, the determination unit 201 determines that the change in weight is not a change made by a store clerk. In addition, when the amount of change in weight of the product shelf 21 is within the predetermined range, the determination unit 201 determines that the change in weight is a change made by a store clerk. Alternatively, when the amount of change in weight of the product shelf 21 is within the predetermined range, the determination unit 201 may also determine whether the change is made by a store clerk using another determination method.

<Determination Method Using Beacon Device and the Like>

Lastly, as a determination method performed by the determination unit 201, a determination method using a beacon device or the like will be described. When a change in display state on the product shelf 21 is detected, the determination unit 201 determines whether the change in display state is a change made by a store clerk depending on whether a device communicating with the beacon device in a wireless manner is a store clerk's device. For example, the beacon device is provided on the product shelf 21. Which one of the beacon device and the store clerk's device transmits a beacon signal is not particularly limited. Here, the beacon device and the information processing device 20 can communicate with each other via a network or the like. The beacon device and the information processing device 20 may be the same device. For example, a case where a beacon signal is transmitted from the store clerk's device will be described. Specifically, for example, in a case where the beacon device receives a beacon signal from the store clerk's device when a change in display state on the product shelf 21 is detected, the determination unit 201 determines that the change in display state is a change made by the store clerk. In a case where the beacon device does not receive a beacon signal when a change in display state on the product shelf 21 is detected, the determination unit 201 determines that the change in display state is not a change made by the store clerk.

Here, the description of each determination method performed by the determination unit 201 ends. One determination method may be performed, or a combination of determination methods may also be performed. For example, in a case where it is determined that the change is made by the store clerk by a plurality of determination methods, the determination unit 201 may affirmatively decide that the change in display state is made by the store clerk. Furthermore, the determination unit 201 may switch between various determination methods. For example, in a case where it cannot be determined whether the change in display state is made by the store clerk by one of the plurality of determination methods, the determination unit 201 may determine whether the change in display state is made by the store clerk by another one of the plurality of determination methods.

Next, the identification unit 203 and the generation unit 202 will be described. The generation unit 202 has the same function as the generation unit 102 described in the first example embodiment. The identification unit 203 is a functional unit newly added to the second example embodiment.

Here, the description will be made on the assumption that only identical products need to be displayed on each product shelf 21 or each shelf board of the product shelf 21. Even a store clerk may erroneously display a product. Therefore, the information processing device 20 generates shelf allocation information based on the identicalness of the products displayed on the product shelf 21.

First, when a change in display state is detected, the identification unit 203 identifies products displayed on the product shelf 21 based on an image of the display state. A conventional technology may be used as a product identification method. For example, the identification unit 203 identifies shapes of products, names of products, colors of products, barcodes of products, product codes, and the like from the image of the display state. Here, for example, even if product “A1” and product “A2” are of the same type (the same contents), if they are different in flavor or amount, the product “A1” and the product “A2” are different products. In addition, here, for example, a melon-flavored juice of 180 ml and a strawberry-flavored juice of 180 ml produced by the same manufacturer are different products. In addition, here, a can beer of 350 ml and a can beer of 500 ml produced by the same manufacturer and have the same contents are different products. The differences between the products are identified, for example, based on the shapes of the products, the names of the products, and the product codes described above. Alternatively, the identical products may be defined as being identifiable, for example, based on the names or the products or the product codes.

Next, the generation unit 202 generates shelf allocation information. The generated shelf allocation information is stored in the storage unit 210, a storage unit of another device accessible via the communication network, or the like. Here, the generation unit 202 will be described with a plurality of generation examples.

### First Generation Example

When the products identified by the identification unit 203 are identical, the generation unit 202 generates shelf allocation information about the displayed products. On the other hand, when the products identified by the identification unit 203 are different, the generation unit 202 does not generate shelf allocation information about the displayed products. An product shelf 21 on which melon-flavored juices are displayed will be described as an example. In a case where three melon-flavored juices are identified from an image of a display state on the product shelf 21, the generation unit 202 generates shelf allocation information about the melon-flavored juices. On the other hand, for example, in a case where two melon-flavored juices and one strawberry-flavored juice are identified from an image of a display state on the product shelf 21, the generation unit 202 does not generate shelf allocation information. As a result, when the products are correctly displayed on the product shelf 21 by the store clerk, the information processing device 20 can generate shelf allocation information.

### Other Generation Examples

For example, in a case where a plurality of individual products is identical among the displayed products acquired by the identification unit 303, the generation unit 302 may generate shelf allocation information about the identical products. A case where two melon-flavored juices and one strawberry-flavored juice are identified will be described. The generation unit 202 generates shelf allocation information about the melon-flavored juices. On the other hand, the generation unit 202 does not generate shelf allocation information regarding the strawberry-flavored juice. As a result, when a plurality of identical products is displayed, the information processing device 20 can generate shelf allocation information about the identical products, assuming that the identical products are placed in a correct display state. On the other hand, the generation unit 202 may be configured not to generate shelf allocation information about a product if there is no other identical product among the products identified by the identification unit 203. As a result, the information processing device 20 can prevent generation of shelf allocation information about a product that is likely to have been incorrectly displayed. Furthermore, in a case where it is determined in advance which product is to be displayed on the product shelf 21 based on past shelf allocation information, product information, or the like, the identification unit 203 identifies the predetermined product, for example, from an image of a display state. Then, the generation unit 202 generates shelf allocation information about the predetermined product. A case where it is determined that melon-flavored juices are displayed on the product shelf 21 will be described as an example. For example, in a case where two melon-flavored juices and three strawberry-flavored juices are displayed on the product shelf 21, the identification unit 203 identifies the two melon-flavored juices from an image of a display state. Then, the generation unit 202 generates shelf allocation information about the two melon-flavored juices. As a result, when it is determined in advance which product is to be displayed on the product shelf 21, the information processing device 20 can generate shelf allocation information regarding the determined product.

Furthermore, in a case where it is determined which category of product is to be displayed on the product shelf 21, the information processing device 30 may perform processing in a similar manner as in each of the generation examples described above. The category can be variously changed. For example, juices of the same amount from the same manufacturer may be regarded as the same category. Alternatively, beer cans may be regarded as the same category regardless of manufacturers or amounts. In addition, a group of beverages may be regarded as the same category in a large scale. When the products identified by the identification unit 203 fall under the same category, the generation unit 202 generates shelf allocation information about the displayed products. In addition, for example, when the products identified by the identification unit 203 does not fall under the same category, the information processing device 30 does not generate shelf allocation information. Here, the description of the generation examples ends.

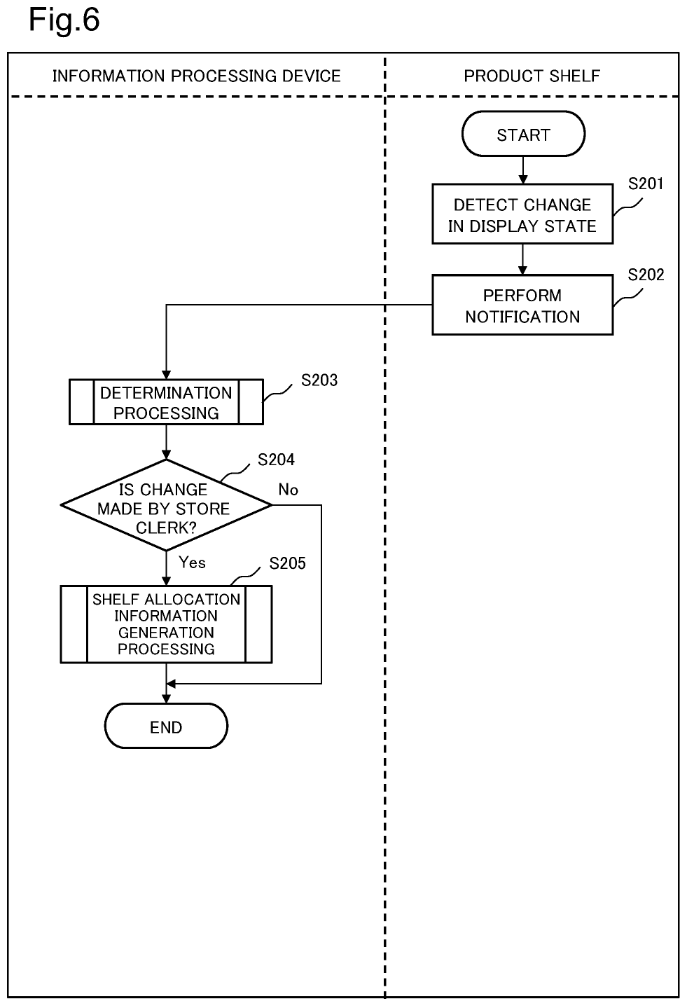

FIG. 6 is a sequence diagram related to an example of an operation of the system 2 according to the second example embodiment. The product shelf 21 detects a change in display state by the detection unit 220 (step S201). Then, the product shelf 21 notifies the information processing device 20 of the change in display state (step S202). In the step S202, the product shelf 21 may also give a notification of an amount of the change and the like. For example, in a case where the detection unit 220 is a weight sensor, the product shelf 21 may give a notification of an amount of change in weight.

Next, the information processing device 20 is notified of the change in display state. Then, the information processing device 20 performs determination processing (step S203). For the determination processing, the above-described various determination methods may be used. The information processing device 20 determines whether the change in display state is a change made by a store clerk (step S204). Although the step S204 is a part of the determination processing, the step S204 is described as a step different from the step S203 for easy description and easy understanding.

When the change in display state is a change made by a store clerk (step S204: Yes), the information processing device 20 performs shelf allocation information generation processing (step S205). Here, in the step S205, the shelf allocation information generation processing also includes product identification processing performed by the identification unit 203. After the step S205, the information processing device 20 ends the operation of the flow. When the change in display state is not a change made by a store clerk (step S204: No), the information processing device 20 ends the operation of the flow.

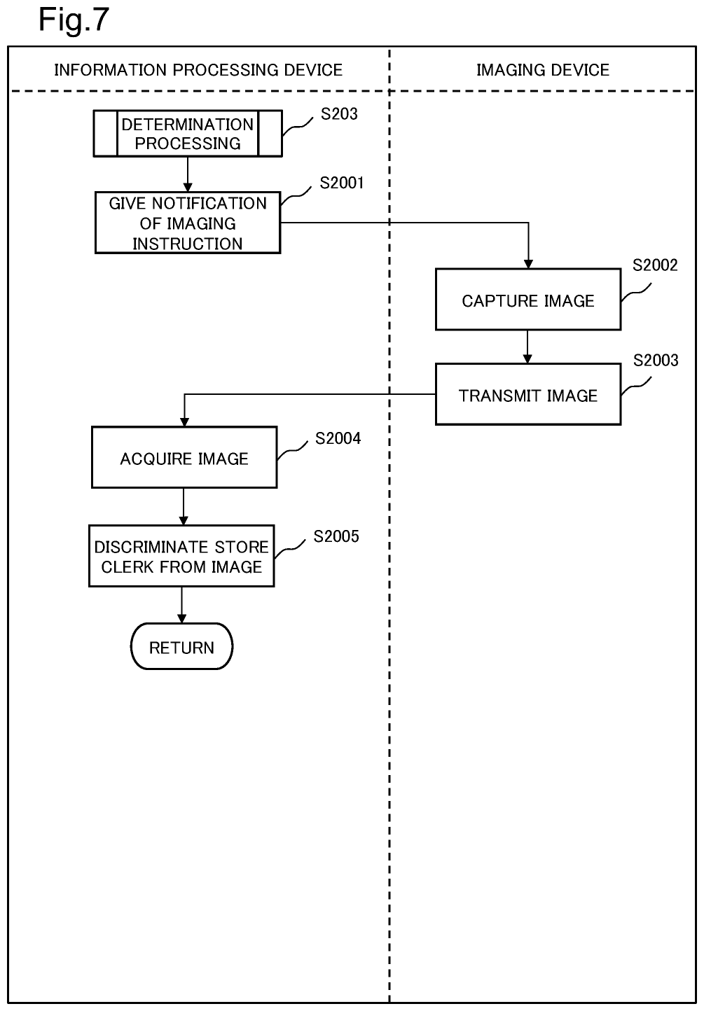

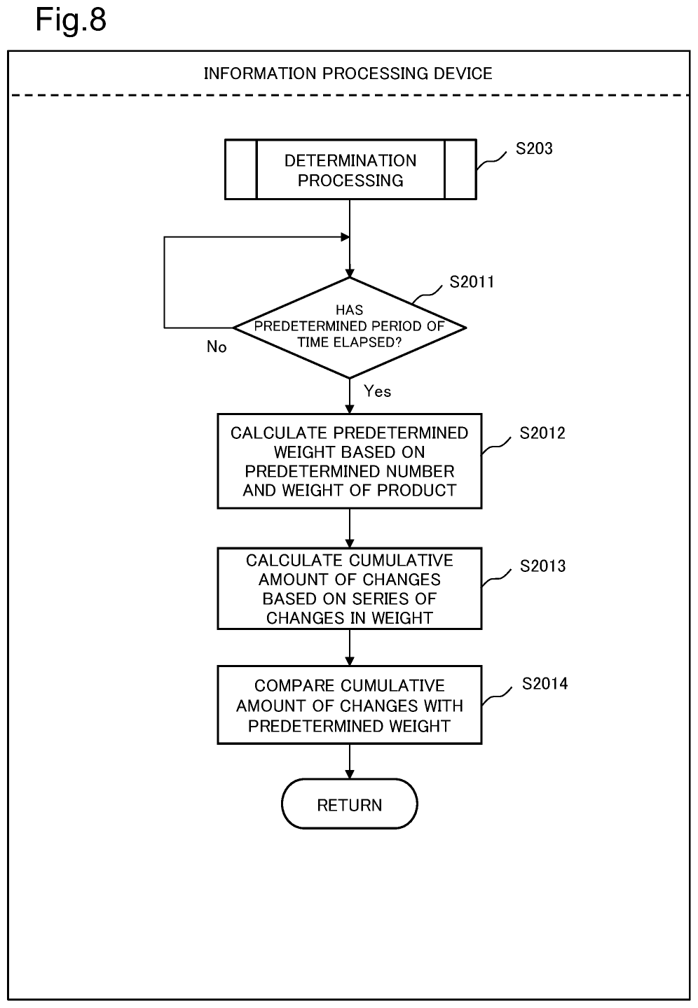

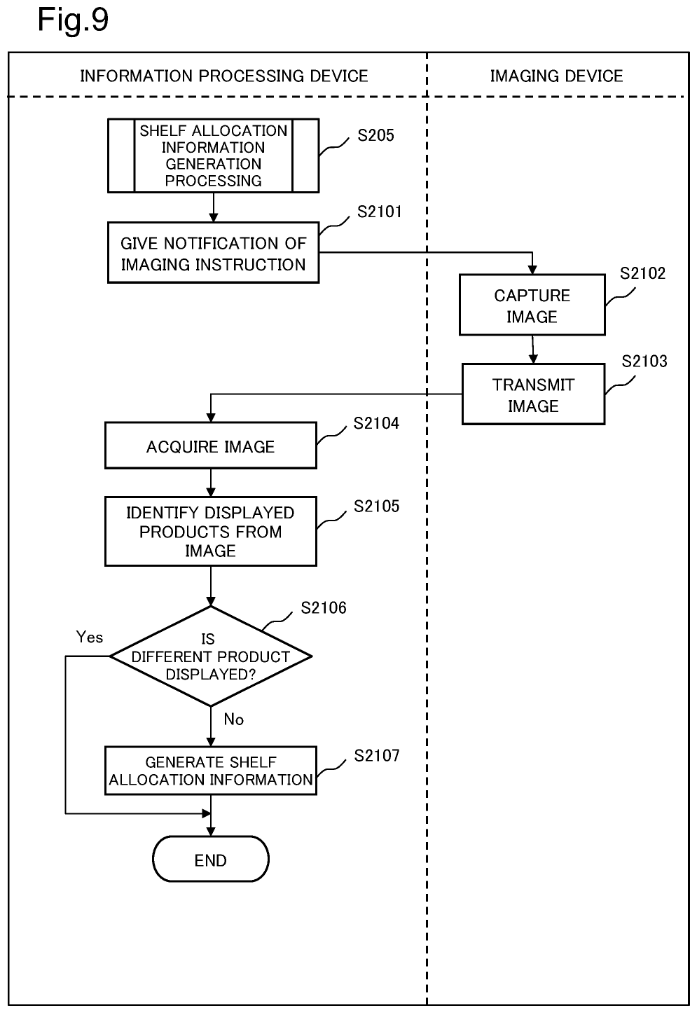

Next, an example of the determination processing (step S203) illustrated in FIG. 6 will be described with reference to FIGS. 7 and 8. In FIG. 7, determination processing using an image will be described. In FIG. 8, determination processing using a cumulative amount of changes in weight will be described. Thereafter, an example of the generation processing (step S205) illustrated in FIG. 6 will be described with reference to FIG. 9.

FIG. 7 is a sequence diagram illustrating an example of the determination processing using an image. First, in FIG. 7, the information processing device 20 notifies the imaging device 22 of an imaging instruction (step S2001). Next, the imaging device 22 captures an image including the product shelf 21, a person in front of the product shelf 21, and the like (step S2002). For example, in the step S2002, the imaging device 22 may capture images from a plurality of angles. In FIG. 9 to be described below, an image of a display state is used to generate shelf allocation information. Therefore, in the step S2002, the imaging device 22 may capture an image of a display state and an image including the periphery of the peripheral shelf.

Next, the information processing device 20 transmits the captured image (step S2003). Then, the information processing device 20 acquires the image (step S2004). Next, the information processing device 20 discriminates a store clerk from the image (step S2005). After the step S2005, the information processing device 20 returns to the original flow. Specifically, after the determination processing (step S203) in FIG. 6, the information processing device 20 transitions the processing to the step S204. The step S2005 and the step S204 illustrated in FIG. 6 may be one step. In addition, as described above, examples of the determination method using the image in the step S2005 may include biometric authentication, movement tracing, matching based on a uniform or the like, and the like.

FIG. 8 is a sequence diagram illustrating an example of the determination processing using a change in weight. First, in FIG. 8, the information processing device 20 determines whether a predetermined period of time has elapsed from a time when a change in display state was detected (step S2011). When the predetermined period of time has not elapsed (step S2011: No), the information processing device 20 returns to the step S2011. As a result, a series of changes in display state within the predetermined period of time from the time when the change in display state is detected can be obtained. When the predetermined period of time has elapsed (step S2011: Yes), the information processing device 20 calculates a predetermined weight based on a predetermined number and a weight of a product (step S2012). The step S2012 may be a step of acquiring a predetermined weight calculated in advance from storage unit 210 or the like. Then, the information processing device 20 calculates a cumulative amount of changes based on the series of changes in weight (step S2013). For example, in the step S2013, the information processing device 20 can calculate the cumulative amount of changes by summing a series of amounts of changes in weight. Then, the information processing device 20 compares the cumulative amount of changes with the predetermined weight (step S2014). After the step S2014, the information processing device 20 returns to the original flow. Specifically, after the step S203 in FIG. 6, the information processing device 20 transitions to the step S204.

FIG. 9 is a sequence diagram illustrating an example of the shelf allocation information generation processing. In FIG. 9, the above-described first generation example will be described. Here, as described above, it is required that identical products be displayed. First, in FIG. 9, the information processing device 20 notifies the imaging device 22 of an imaging instruction (step S2101). Next, the imaging device 22 captures an image of a display state of the product shelf 21 (step S2102). Next, the information processing device 20 transmits the captured image (step S2103). Then, the information processing device 20 acquires the image (step S2104). The information processing device 20 identifies products displayed on the product shelf 21 from the image (step S2105). Then, the information processing device 20 determines whether a different product is displayed (step S2106). When a different product is displayed (step S2106: Yes), the information processing device 20 ends the operation of the flow. For example, in a case where two melon-flavored juices and one strawberry-flavored juice are displayed, shelf allocation information is not generated. As a result, in a case where a different product is displayed on the product shelf 21, shelf allocation information is not generated. Note that, since there is no step after the step S205 in FIG. 6, in the case of Yes in step S2106, the information processing device 20 ends the operation of the flow.

When a different product is not displayed (step S2106: No), the information processing device 20 generates shelf allocation information (step S2107). Then, after the step S2107, the information processing device 20 ends the operation of the flow. For example, in a case where three melon-flavored juices are displayed, shelf allocation information about the melon-flavored juices is generated.

In a case where the determination method using an image as illustrated in FIG. 7 is performed as a determination method performed by the determination unit 201, the steps S2101 to S2104 in FIG. 9 may be the same as the steps S2001 to S2004 illustrated in FIG. 7, respectively. In such a case, the information processing device 20 may start the flow from S2105 in the generation processing (step S205).

Next, an effect of the second example embodiment will be described. Similarly to the first example embodiment, the information processing device 20 generates shelf allocation information in a case where the change in display state of the product on the product shelf is a change made by the store clerk. As a result, the information processing device 20 can generate shelf allocation information in a state where the product is more correctly displayed on the product shelf. Furthermore, the information processing device 20 can suppress generation of shelf allocation information at a timing when the product is not displayed in a correct state. Therefore, the information processing device 20 can improve accuracy of shelf allocation information. First, an effect of each of the determination methods described in the second example embodiment, while not described in the first example embodiment, will be described.

Next, an effect of the determination method using an image will be described. The information processing device 20 determines whether the change in display state is a change made by a store clerk by discriminating the store clerk from the image. In addition, a conventional technology such as biometric authentication, uniform image matching, movement tracing, or the like can be used. As a result, the information processing device 20 can accurately determine whether the change in display state has been made by the store clerk. Furthermore, the information processing device 20 acquires an image from the imaging device 22 at the time of generating shelf allocation information. Therefore, by making a determination using the image, the information processing device 20 does not need a new component or the like added for determination.

Next, the effect of the determination method using a change in weight will be described. For example, a pattern of a change in weight when a product is displayed by a store clerk is different from that when a product is placed back or taken out by a customer. Therefore, the information processing device 20 determines whether the change in display state is a change made by a store clerk based on a series of changes in weight within the predetermined period of time from the time when the change in display state is detected. As a result, it is possible to accurately determine whether a change in display state has been made by a store clerk, depending on the characteristics of store clerk's display work. Furthermore, in a case where a change in display state is detected by the weight sensor, the information processing device 20 does not need a new component or the like added for determination.

In addition, an effect of the first generation example in a case where only identical products are displayed on the product shelf 21 will be described. When products identified from an image of a display state are identical, the information processing device 20 generates shelf allocation information about the displayed products. As a result, for example, in a case where three melon-flavored juices are identified from an image of a display state of the product shelf 21, shelf allocation information about the melon-flavored juices is generated. Therefore, when the products are correctly displayed on the product shelf 21 by the store clerk, the information processing device 20 can generate shelf allocation information Furthermore, the information processing device 20 can generate shelf allocation information with higher accuracy.

### Third Example Embodiment

Next, a third example embodiment will be described in detail with reference to the drawings. Hereinafter, description overlapping with what has been described above will be omitted unless the omission obscures the description of the third example embodiment.

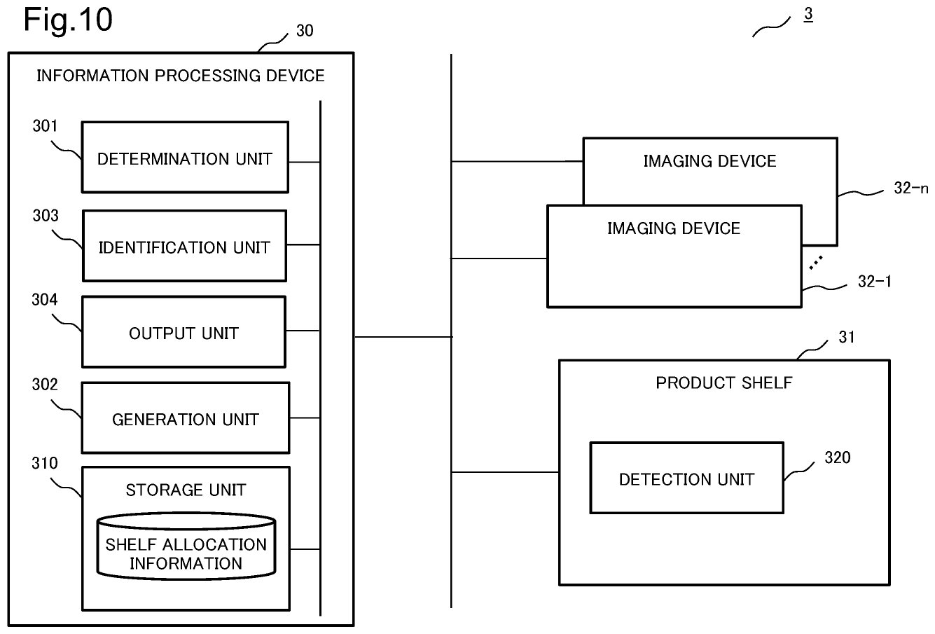

FIG. 10 is a block diagram illustrating an example of a configuration of a system 3 according to the third example embodiment. The system 3 corresponds to the system 2 according to the second example embodiment. The system 3 includes an information processing device 30, a product shelf 31, and an imaging device 32. The product shelf 31 includes a detection unit 320. The product shelf 31 is identical to the product shelf 21 according to the second example embodiment. Therefore, the description of the product shelf 31 will be omitted. Furthermore, the imaging device 32 is identical to the imaging device 22 according to the second example embodiment. The description of the imaging device 32 will also be omitted.

The information processing device 30 corresponds to the information processing devices 10 and 20 according to the first and second example embodiments. The information processing device 30 includes a determination unit 301, an identification unit 303, an output unit 304, a generation unit 302, and a storage unit 310. In the third example embodiment, the information processing device 30 newly includes an output unit 304. The determination unit 301 has the same function as the determination units 101 and 201 according to the first and second example embodiments. The generation unit 302 has the same function as the generation units 102 and 202 according to the first and second example embodiments. The identification unit 303 has the same function as the identification unit 203 according to the second example embodiment. The storage unit 310 may be identical to, for example, the storage unit 210 according to the second example embodiment.

In the third example embodiment, differences from the second example embodiment will be described. In the second example embodiment, the first generation example was performed on the assumption that only identical products needed to be displayed on the product shelf 31. In the third example embodiment, in this case, when a different product is displayed on the product shelf 31, the fact is notified to a store clerk.

When a plurality of products acquired by the identification unit 303 is different, the output unit 304 notifies a store clerk of the fact. A method of notifying the store clerk is not particularly limited. Examples of the notification method include transmitting an electronic mail or an electronic message, outputting a notification to an output device, and the like. The output unit 304 outputs, for example, to an output device of the information processing device 30, the fact that the products are different. Alternatively, for example, the output unit 304 may notify a store clerk's device that the products are different. The store clerk's device is a management terminal device of a store or a terminal device of a store clerk. Alternatively, for example, the output unit 304 may notify an output device or the like provided on the product shelf 31 that the products are different. For example, in a case where two melon-flavored juices and one strawberry-flavored juice are identified from an image of a display state of the product shelf 31, the plurality of products identified by the identification unit 303 is different. In addition, in a case where one melon-flavored juice and one strawberry-flavored juice are identified from an image of a display state of the product shelf 31, the plurality of products identified by the identification unit 303 is different. In a case where the identification result is as described above, the output unit 304 notifies a store clerk of the fact. As a result, the information processing device 30 can notify a store clerk that there is a possibility that the products are incorrectly displayed on the product shelf 31 by the store clerk. On the other hand, when three melon-flavored juices are identified from an image of a display state of the product shelf 31, all the products are identical. Therefore, the output unit 304 does not notify the store clerk.

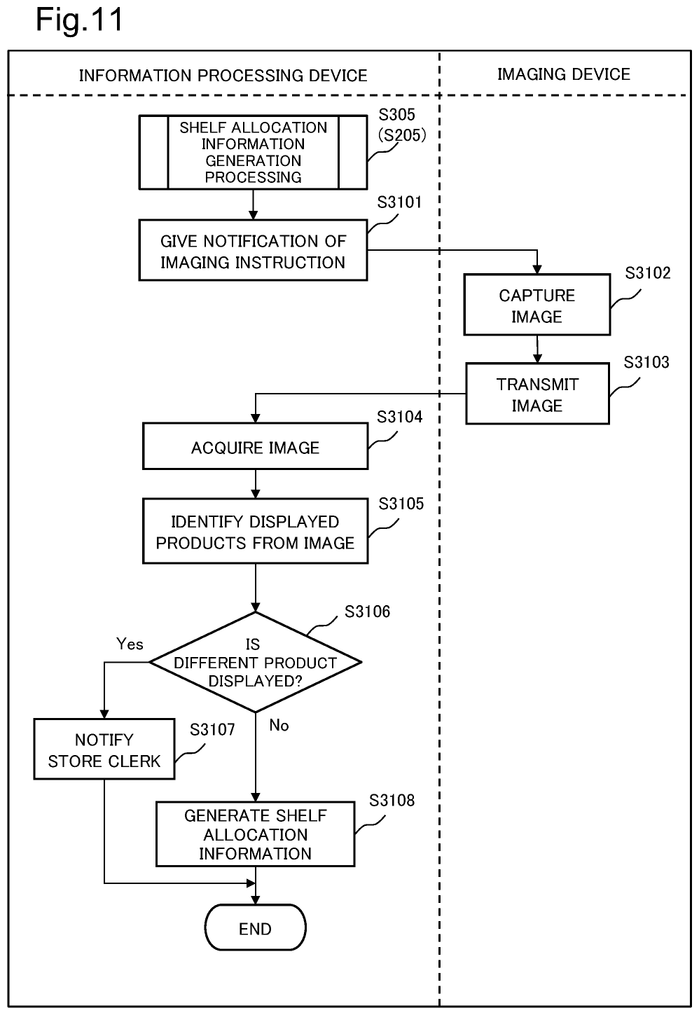

The third example embodiment can be variously modified. For example, the second example embodiment and the third example embodiment may be implemented in combination. For example, the first generation example and the notification of the output unit 304 to the store clerk may be implemented in combination. For example, in a case where there is a different product on the product shelf 31, the information processing device 30 notifies the store clerk that there is a different product. On the other hand, in a case where there is no different product on the product shelf 31, the information processing device 30 generates shelf allocation information about identified products. An example of the combination of the example embodiments is illustrated in a flowchart of FIG. 11.

Furthermore, in a case where it is determined that products of the same category need to be displayed on the product shelf for each category of products, when products of different categories are identified from an image, the output unit 304 may notify a store clerk that products of the fact.

Furthermore, for example, when an amount of change in weight of the product shelf 21 is not within the predetermined range, the output unit 304 may notify a store clerk of the fact. As described above, even when an abnormal display state is detected, the output unit 304 may notify the store clerk of the fact.

In addition, in the third example embodiment, in a case where a plurality of individual products is identical, a shelf allocation information candidate about the identical products may be generated and notified to a store clerk. Then, the store clerk may determine whether to adopt the shelf allocation information candidate. Furthermore, the store clerk may check the product shelf 31 after obtaining the shelf allocation information candidate. Furthermore, the store clerk may correct the shelf allocation information candidate. Specifically, in a case where a plurality of individual products is identical among the displayed products acquired by the identification unit 303, the generation unit 302 may generate a shelf allocation information candidate about the identical products. Then, the output unit 304 notifies the store clerk of the generated shelf allocation information candidate. Here, the notification method is not particularly limited. For example, a method similar to the method of notifying the store clerk may be adopted as a notification method. Furthermore, the information processing device 30 may receive, from the store clerk, whether the shelf allocation information candidate is adopted. For example, when the shelf allocation information candidate is adopted, the shelf allocation information candidate is stored as shelf allocation information in the storage unit 310. When the shelf allocation information candidate is not adopted, the shelf allocation information candidate may be discarded. Furthermore, the shelf allocation information candidate may be corrected by a store clerk. For example, the corrected shelf allocation information candidate is stored as shelf allocation information in the storage unit 310. In order to achieve such a function, the information processing device 30 may further include a functional unit such as a selection unit or a reception unit, although not illustrated. For example, in a case where two melon-flavored juices and one strawberry-flavored juice are identified from an image of a display state, the generation unit 302 generates a shelf allocation information candidate about the melon-flavored juices. On the other hand, the generation unit 202 does not generate a shelf allocation information candidate about the strawberry-flavored juice. Then, the output unit 304 notifies a store clerk of the shelf allocation information candidate about the melon-flavored juices.

Next, an example of an operation of the system 3 according to the third example embodiment will be described. Since a sequence diagram therefor may be the same as that in FIG. 6 according to the second example embodiment, the description thereof will be omitted. However, shelf allocation information generation processing will be described with reference to FIG. 11.

FIG. 11 is a sequence diagram illustrating an example of the shelf allocation information generation processing according to the third example embodiment. FIG. 11 illustrates an example in which the first generation example described in the second example embodiment is combined with the function of the output unit 304. The above-described shelf allocation information generation processing illustrated in FIG. 6 (step S205) may be replaced with the shelf allocation information generation processing illustrated in FIG. 11 (step S305).

The sequence diagram illustrated in FIG. 11 is different from the sequence diagram illustrated in FIG. 9 in that step S3107 is added. In FIG. 11, steps S3101 to S3106 are the same as the steps S2101 to S2106 illustrated in FIG. 9, respectively. Here, the description of the steps S3101 to S3105 will be omitted.

After the step S3105, the information processing device 30 determines whether a different product is displayed (step S3106). When a different product is displayed (step S3106: Yes), the information processing device 30 notifies a store clerk that a different product is displayed (step S3107). After the step S3107, the information processing device 30 ends the operation of the flow. On the other hand, when a different product is not displayed (step S3106: No), the information processing device 30 generates shelf allocation information (step S3108). After the step S3108, the information processing device 30 ends the operation of the flow.

Next, an effect of the third example embodiment will be described. For example, only identical products may be displayed on the product shelf 31. In a case where different products are displayed, there is a possibility that one of the different products is incorrectly displayed by a store clerk. Therefore, in a case where a different product is identified from an image of a display state, the information processing device 30 notifies the store clerk that a different product is identified. As a result, the information processing device 30 can urge the store clerk to display the product more correctly on the product shelf 31. For example, the store clerk can check the display state of the product because of this notification. For example, the store clerk can redo display work. Furthermore, the information processing device 30 can improve accuracy of shelf allocation information.

Furthermore, in a case where a plurality of individual products is identical among the products identified from the image of the display state, the information processing device 30 generates a shelf allocation information candidate about the identical products, and notifies the store clerk of the shelf allocation information candidate. As a result, when a plurality of identical products is displayed, the information processing device 30 can generate a shelf allocation information candidate about the identical products, assuming that there is a high possibility that the products are placed in a correct display state. Then, the information processing device 30 notifies the store clerk of the shelf allocation information candidate. As a result, the information processing device 30 can notify the store clerk of the shelf allocation information candidate to be noted. Furthermore, the information processing device 30 improve accuracy of shelf allocation information. Furthermore, the information processing device 30 can prevent generation of shelf allocation information about a product that is likely to have been incorrectly displayed.

### Fourth Example Embodiment

An example in which the product shelf is divided into a plurality of regions will be described. The plurality of regions may be divided in any manner. The plurality of regions is defined by, for example, plates or containers. In the case of plates, a region where products can be placed on a plate is defined as one region. In the case of a container, a region of one container is defined as one region. Here, an example in which a plurality of regions is distinguished from each other by a plurality of containers will be described.

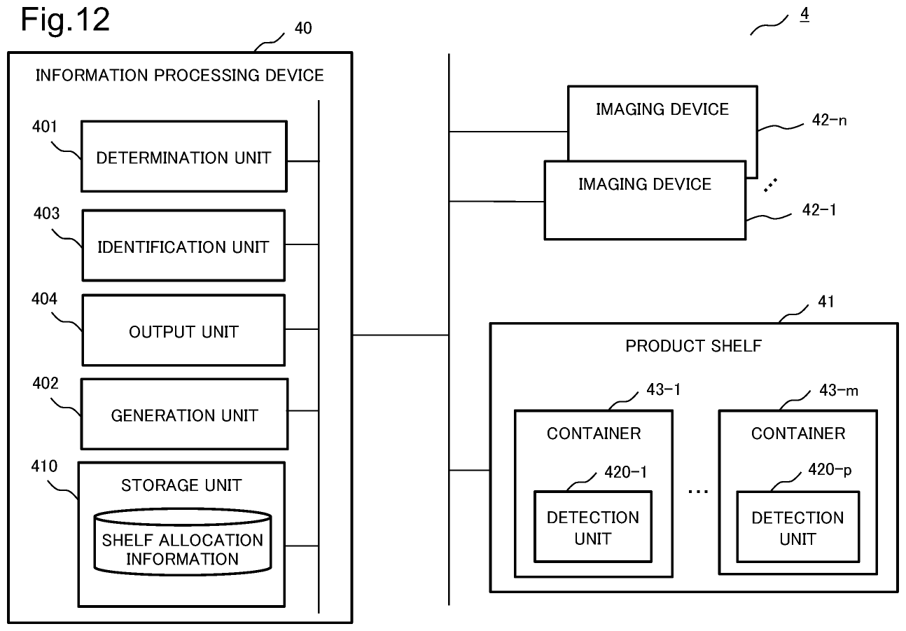

FIG. 12 is a block diagram illustrating an example of a configuration of a system according to a fourth example embodiment. The system 4 according to the fourth example embodiment includes an information processing device 40, a product shelf 41, and an imaging device 42. In the fourth example embodiment, a plurality of containers 43-1 to 43-m included in the product shelf 41 is newly added. In addition, detection units 420-1 to 420-p provided for the respective containers 43 are newly added. Here, m is an integer of 2 or more. p is an integer of 1 or more. m and p may be equal. m and p may be different values. For example, the detection unit 420 may not be provided for every container 43. In addition, a plurality of detection units 420 may be provided for some of the containers 43. The detection unit 420 has the same function as the detection units 220 and 320 described above. Thus, the detection unit 420 detects a change in display state of the container 43.

The imaging device 42 is has the same function as the imaging devices 22 and 32 described above. The information processing device 40 corresponds to the information processing devices 10, 20, and 30 according to the first to third example embodiments. The information processing device 40 has no difference in its components from the information processing device 30 according to the third example embodiment. Each of the components of the information processing device 40 has the same function as the related one of the components of the information processing device 30.

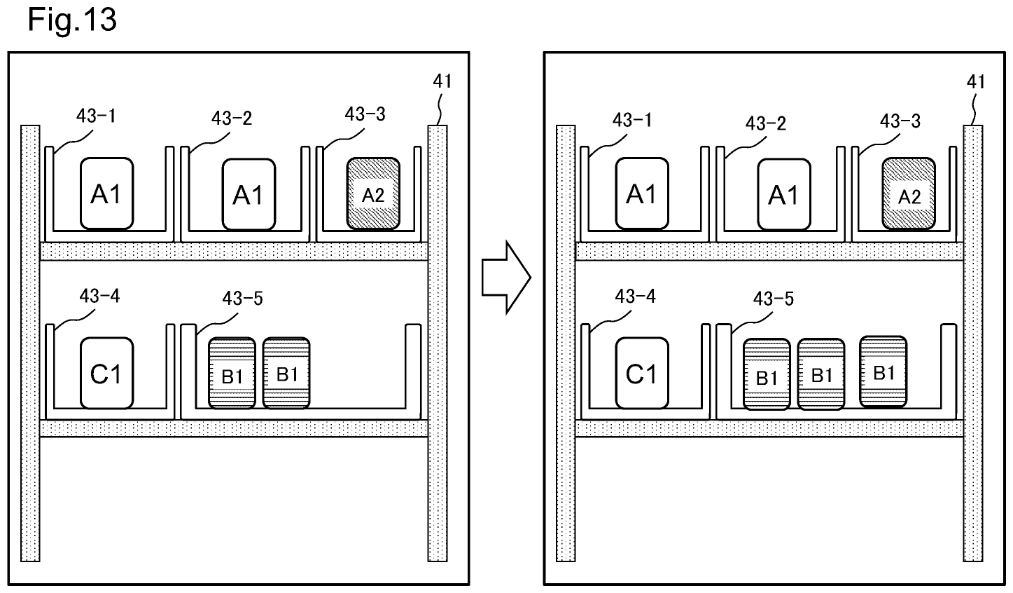

Next, specific processing in the fourth example embodiment will be described. The generation unit 402 generates shelf allocation information for a container 43 (a region) in which a change in display state has been detected among the plurality of containers 43 (the plurality of regions). A specific example will be described with reference to FIG. 13.

FIG. 13 is an explanatory diagram illustrating an example of a change in display state of the container 43. In the example of FIG. 13, the product shelf 41 is divided into a plurality of stages by a plurality of plates. In the product shelf 41, products can be placed on each of the plates. Furthermore, containers 43 are provided on each of the plates. In this manner, the product shelf 41 is divided by the plurality of containers 43.

In the example of FIG. 13, product “B” is newly displayed in a container 43-5. Specifically, the detection unit 420-5 detects a change in display state of the container 43-5. Then, when the change in display state of the container 43-5 is detected, the determination unit 401 determines whether the change in display state is a change made by a store clerk. When the change in display state of the container 43-5 is a change made by a store clerk, the generation unit 402 generates shelf allocation information for the container 43-5.

Furthermore, for example, it may be determined in advance that identical products need to be displayed in each of the plurality of containers 43. In such a case, processing (e.g., the first generation example) or the like performed by the identification unit 403 and the generation unit 402 in the third example embodiment may be performed for each product shelf 41.

Each of the generation examples described in the second example embodiment may be performed in units of containers 43. Here, an example in which the first generation example described in the second example embodiment is applied to the fourth example embodiment will be described with reference to FIG. 13. The identification unit 403 identifies products displayed in the container 43-5 based on an image of a display state. The image of the display state may be an image of an entire portion of the product shelf 41. Furthermore, the image of the display state may be an image of a partial portion of the product shelf 41 including the container 43-5. When the displayed products acquired by the identification unit 403 are identical, the generation unit 402 generates shelf allocation information about the products “B1” displayed in the container 43-5. On the other hand, when a product different from the product “B1” is displayed in the container 43-5, the generation unit 402 does not generate shelf allocation information.

In addition, the notification to the store clerk described in the third example embodiment may be performed in units of containers 43. For example, on the assumption that only identical products need to be displayed in the container 43, when a different product is identified in the container 43 in which a change in display state has been detected from the image of the display state, the output unit 404 notifies a store clerk of the fact.

In addition, an example in which the notification of the shelf allocation information candidate to the store clerk described in the third example embodiment is applied to the fourth example embodiment will be described. For example, an example in which two products “B1” and one product “B2” different from the product “B1” are identified in the container 43-5 by the identification unit 403 will be described. In a case where a plurality of individual products is identical among the products “B1” and “B2” displayed in the container 43-5, a shelf allocation information candidate about the identical products is generated. That is, the generation unit 402 generates a shelf allocation information candidate about the products “B1” displayed in the container 43-5. On the other hand, the generation unit 402 does not generate a shelf allocation information candidate about the product “B2” displayed in the container 43-5. Then, the output unit 404 notifies the store clerk of the shelf allocation information candidate.

Next, an effect of the fourth example embodiment will be described. The information processing device 40 generates shelf allocation information for a container 43 (a region) in which a change in display state has been detected among the plurality of containers 43 (the plurality of regions). In this manner, the information processing device 40 can generate shelf allocation information not for the entire product shelf 41 but in small units of containers 43 (regions) obtained by dividing the product shelf 41. As a result, the information processing device 40 can generate shelf allocation information more accurately.

In addition, each of the containers 43 may be disposed on the product shelf 41 in any manner. As illustrated in FIG. 13, one or more containers 43 may be disposed on each plate of the product shelf 41. For example, the container 43 may be mounted on the product shelf 41 in a hooked manner.

The first to fourth example embodiments may be combined together. Furthermore, the information processing devices 10, 20, 30, and 40 according to the first to fourth example embodiments may be combined together with conventional technologies.

FIG. 14 illustrates an example of a hardware configuration of a system. A system 5 includes, for example, an information processing device 50, a product shelf 51, and an imaging device 52. First, a case where the information processing devices 10, 20, 30, and 40 according to the first to fourth example embodiments are implemented by a computer will be described. The information processing device 50 is an example in which, for example, the information processing devices 10, 20, 30, and 40 are implemented by a computer. The information processing device 50 includes a central processing unit (CPU) 501, a ROM 502, a RAM 503, a storage device 504, and a communication interface 505. These components are connected to each other via a bus 506.

The CPU 501 controls the information processing device 50 overall. For example, the CPU 501 may control the information processing device 50 overall by operating an operating system (OS). The CPU 501 may have a plurality of cores.

The information processing device 50 includes a ROM 502, a RAM 503, a storage device 504, and the like as storage units. Examples of the storage device 504 include a semiconductor memory such as a flash memory, an HDD, and an SSD. For example, the storage device 504 stores various programs such as an OS program, an application program, and programs according to the first to fourth example embodiments. Alternatively, the ROM 502 stores an application program. In addition, the ROM 502 may also store programs according to the first to fourth example embodiments. Then, the RAM 503 is used as a work area of the CPU 501.

In addition, the CPU 501 loads a program stored in the storage device 504, the ROM 502, or the like. Then, the CPU 501 executes each process coded in the program. Furthermore, the CPU 501 may download various programs via a communication network 510. Furthermore, the CPU 501 functions as some or all of the information processing device 50. Also, the CPU 501 may execute a process or an instruction in the illustrated flowchart based on the program.

The communication interface 505 is connected to the communication network 510 such as a local area network (LAN) or a wide area network (WAN) through a wireless or wired communication line. As a result, the information processing device 50 is connected to an external device or an external computer via the communication network 510. The communication interface 505 serves as an interface between the communication network 510 and the inside of the information processing device 50. Also, the communication interface 505 controls input and output of data from and to an external device or an external computer.

However, the hardware configuration illustrated in FIG. 14 is an example, and other components may be added or some components may not be included. For example, the information processing device 50 may include a drive device or the like. Then, the CPU 501 may read a program or data from a recording medium mounted on the drive device or the like to the RAM 503. Examples of the recording medium include an optical disk, a flexible disk, a magnetic optical disk, a universal serial bus (USB) memory, and the like. Furthermore, for example, the information processing device 50 may include an input device such as a keyboard or a mouse. The information processing device 50 may also include an output device such as a display.

Next, a hardware configuration of a product shelf 51 described in each example embodiment will be described. The product shelf 51 includes, for example, a sensor 511 (detection unit) and a communication interface 512. The communication interface 512 and each sensor 511 are connected to each other via a bus 513. The sensor can be variously changed, such as a weight sensor, a distance sensor, a pressure sensor, or a human body sensor. The communication interface 512 is connected to the communication network 510 such as a LAN or a WAN through a wireless or wired communication line.

As illustrated in the drawing, the product shelf 51 may include a plurality of sensors 511. The number (value of p) and the type of the sensors 511 are not particularly limited. The number and the type of the sensors 511 can be variously changed, for example, depending on which example embodiment the sensors are used in or what determination method is used.

Not limited to what is illustrated, the product shelf 51 may include a microcomputer, a processor, and the like. As a result, the information processing device 50 may cause the product shelf 51 to perform simple calculation and the like. In addition, the product shelf 51 may include an output device, an input device, and the like. Furthermore, the communication interface 512, the sensor 511, and the like may be built in the product shelf 51. Alternatively, the communication interface 512, the sensor 511, and the like may be externally attached to the product shelf 51. In a case where the communication interface 512, the sensor 511, and the like are externally attached to the product shelf 51, each example embodiment can be implemented even using a conventional product shelf 51. In addition, the communication interface 512, the sensor 511, and the like may not be in direct physical contact with the product shelf 51.

Next, an example of a hardware configuration of the imaging device 52 will be described. The imaging device 52 includes a camera 521 and a communication interface 522. These components are connected to each other by a bus 523. The communication interface 522 is connected to the communication network 510 such as a LAN or a WAN, for example, through a wireless or wired communication line. The imaging device 52 has a function capable of capturing an image. Furthermore, the imaging device 52 may be capable of capturing a moving image. Furthermore, a plurality of imaging devices 52 may be provided as described above.

As described above, the information processing devices 10, 20, 30, and 40 according to the first to fourth example embodiments are implemented by the computer hardware illustrated in FIG. 14. Furthermore, the information processing devices 10, 20, 30, and 40 are implemented by one physically combined device. Alternatively, the information processing devices 10, 20, 30, and 40 may be implemented by connecting two or more physically separated device in a wired or wireless manner. A case where a system including a determination unit 201, a generation unit 202, and a detection unit 220 is implemented will be described as an example. The detection unit 220 is included in the product shelf 21. On the other hand, the determination unit 201 and the generation unit 202 are included in the information processing device 20. Alternatively, for example, the determination unit 201 is included in the information processing device 20. Then, the generation unit 202 may be included in a device different from the information processing device 20. In addition, a case where a system including a determination unit 301, an identification unit 303, an output unit 304, a generation unit 302, and a detection unit 320 is implemented will be described as an example. The detection unit 320 is included in the product shelf 31. The determination unit 301 is included in the information processing device 30. Then, the identification unit 303, the output unit 304, and the generation unit 302 may be included in a device different from the information processing device 30.

In addition, there are various modifications of the methods for implementing the information processing devices 10, 20, 30, and 40. For example, each of the devices may be implemented by any combination of a program with a computer different for each component. In addition, a plurality of components included in each of the devices may be implemented by any combination of a program with one computer.

In addition, some or all of the components of the information processing devices 10, 20, 30, and 40 may be implemented by a circuit for specific use. In addition, some or all of the information processing devices 10, 20, 30, and 40 may be implemented by a general-purpose circuit including a processor such as a field programmable gate array (FPGA). Furthermore, some or all of the information processing devices 10, 20, 30, and 40 may be implemented by a combination of a circuit for specific use, a general-purpose circuit, and the like. In addition, these circuits may be single integrated circuits. Alternatively, these circuits may be divided into a plurality of integrated circuits. The plurality of integrated circuits may be connected to each other via a bus or the like.

In addition, in a case where some or all of the components of each device are implemented by a plurality of computers, circuits, or the like, the plurality of computers, circuits, or the like may be arranged in a centralized manner or in a distributed manner.

The information processing methods described in the example embodiments are implemented by the information processing devices 10, 20, 30, and 40, respectively. Furthermore, the information processing method are implemented by a computer such as the information processing device 10, 20, 30, or 40 executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by the computer when read from the recording medium. Furthermore, the program may be distributed via the communication network 510.

The functions of the components of the information processing devices 10, 20, 30, and 40 in the above-described example embodiments may be implemented in hardware like the functions of the information processing device 50 as a computer illustrated in FIG. 14. Alternatively, the components may be implemented by a computer device or firmware based on the control of the program.

While the present disclosure has been particularly shown and described with reference to example embodiments thereof, the present disclosure is not limited to these example embodiments. It will be understood by those of ordinary skill in the art that various changes in form and details may be applied to the example embodiments without departing from the spirit and scope of the present disclosure as defined by the claims. The present disclosure may include example embodiments in which the matters described in the present specification are appropriately combined or replaced if necessary. For example, the matters described using a specific example embodiment can be applied to another example embodiment as long as no contradiction occurs. For example, although a plurality of operations is described in order in the form of a flowchart, the order in which the operations are described does not limit an order in which the plurality of operations is executed. Therefore, when each example embodiment is implemented, the order in which the plurality of operations is executed can be changed within a range that does not interfere with the content.

Some or all of the above-described example embodiments may be described as in the following Supplementary Notes, but are not limited to the following Supplementary Notes.

(Supplementary Note 1)

An information processing device including:
a determination means configured to, when a change in display state of a product on a product shelf is detected, determine whether the change in display state is a change made by a store clerk; and
a generation means configured to generate shelf allocation information when the change in display state is a change made by the store clerk.

(Supplementary Note 2)

The information processing device according to Supplementary Note 1,
in which the change in display state is a change in weight of the product shelf.

(Supplementary Note 3)

The information processing device according to Supplementary Note 2,
in which the change in weight is an increase in weight of the product shelf.

(Supplementary Note 4)

The information processing device according to any one of Supplementary Notes 1 to 3,
in which the determination means determines that the change in display state is a change made by the store clerk by discriminating the store clerk from a captured image.

(Supplementary Note 5)

The information processing device according to Supplementary Note 2 or 3,
in which the determination means determines that the change in weight is a change made by the store clerk based on a series of changes in weight of the product shelf within a predetermined period of time from a time when the change in weight of the product shelf is detected.

(Supplementary Note 6)

The information processing device according to Supplementary Note 5,
in which the determination means determines that the change in weight is a change made by the store clerk based on a cumulative amount of changes in weight of the product shelf within the predetermined period of time from the time when the change in weight of the product shelf is detected.

(Supplementary Note 7)

The information processing device according to any one of Supplementary Notes 1 to 6, further including
an identification means configured to identify products displayed on the product shelf based on an image of the display state when the change in display state is detected,
in which the generation means generates the shelf allocation information about the displayed products when the displayed products acquired by the identification means are identical.

(Supplementary Note 8)

The information processing device according to any one of Supplementary Notes 1 to 6, further including:
an identification means configured to identify products displayed on the product shelf based on an image of the display state when the change in display state is detected; and
an output means configured to notify the store clerk,
in which when a plurality of individual products is identical among the displayed products acquired by the identification means, the generation means generates a shelf allocation information candidate about the identical products, and
the output means notifies the store clerk of the generated shelf allocation information candidate.

(Supplementary Note 9)

The information processing device according to any one of Supplementary Notes 1 to 6, further including:
an identification means configured to identify products displayed on the product shelf based on an image of the display state when the change in display state is detected; and
an output means configured to notify the store clerk when a plurality of products acquired by the identification means is different.

(Supplementary Note 10)

The information processing device according to any one of Supplementary Notes 1 to 9,
in which the product shelf is divided into a plurality of regions, and
the generation means generates the shelf allocation information for a region in which the change in display state is detected among the plurality of regions.

(Supplementary Note 11)

A system including:
a detection means configured to detect a change in display state of a product on a product shelf;
a determination means configured to determine whether the change in display state is a change made by a store clerk when the change in display state is detected by the detection means; and
a generation means configured to generate shelf allocation information when the change in display state is a change made by the store clerk.

(Supplementary Note 12)

A method including:
when a change in display state of a product on a product shelf is detected, determining whether the change in display state is a change made by a store clerk; and
when the change in display state is a change made by the store clerk, generating shelf allocation information.

(Supplementary Note 13)

A program for causing a computer to execute:
when a change in display state of a product on a product shelf is detected, determining whether the change in display state is a change made by a store clerk; and
when the change in display state is a change made by the store clerk, generating shelf allocation information.

This application is based upon and claims the benefit of priority from Japanese patent application No. 2020-161649, filed on Sep. 28, 2020, the disclosure of which is incorporated herein in its entirety by reference.

### REFERENCE SIGNS LIST

2, 3, 5 system
10, 20, 30, 40, 50 information processing device
21, 31, 41, 51 product shelf
22, 32, 42, 52 imaging device
43 container
101, 201, 301, 401 determination unit
102, 202, 302, 402 generation unit
203, 303, 403 identification unit
210, 310, 410 storage unit
220, 320, 420 detection unit
304, 404 output unit

What is claimed is:

1. An information processing device comprising:
a memory storing instructions; and
one or more processors configured to execute the instructions to:
when a change in display state of a product on a product shelf is detected, determine whether the change in display state is a change made by a store clerk; and
generate shelf allocation information when the change in display state is a change made by the store clerk.

2. The information processing device according to claim 1,
wherein the change in display state is a change in weight of the product shelf.

3. The information processing device according to claim 2,
wherein the change in weight is an increase in weight of the product shelf.

4. The information processing device according to claim 1,
wherein the one or more processors are further configured to execute the instructions to:
determine that the change in display state is a change made by the store clerk by discriminating the store clerk from a captured image.

5. The information processing device according to claim 2,
wherein the one or more processors are further configured to execute the instructions to:
determine that the change in weight is a change made by the store clerk based on a series of changes in weight of the product shelf within a predetermined period of time from a time when the change in weight of the product shelf is detected.

6. The information processing device according to claim 5,
wherein the one or more processors are further configured to execute the instructions to:
determine that the change in weight is a change made by the store clerk based on a cumulative amount of changes in weight of the product shelf within the predetermined period of time from the time when the change in weight of the product shelf is detected.

7. The information processing device according to claim 1, wherein
the one or more processors are further configured to execute the instructions to:
identify products displayed on the product shelf based on an image of the display state when the change in display state is detected,
generate the shelf allocation information about the displayed products when the displayed products acquired are identical.

8. The information processing device according to claim 1, wherein
the one or more processors are further configured to execute the instructions to:
identify products displayed on the product shelf based on an image of the display state when the change in display state is detected; and
notify the store clerk,
when a plurality of individual products is identical among the displayed products acquired by the identification means, generate a shelf allocation information candidate about the identical products, and
notify the store clerk of the generated shelf allocation information candidate.

9. The information processing device according to claim 1, wherein
the one or more processors are further configured to execute the instructions to:
identify products displayed on the product shelf based on an image of the display state when the change in display state is detected; and
notify the store clerk when a plurality of products acquired is different.

10. The information processing device according to claim 1,
wherein the product shelf is divided into a plurality of regions, wherein
the one or more processors are further configured to execute the instructions to:
generate the shelf allocation information for a region in which the change in display state is detected among the plurality of regions.

11. (canceled)

12. A method comprising:
when a change in display state of a product on a product shelf is detected, determining whether the change in display state is a change made by a store clerk; and
when the change in display state is a change made by the store clerk, generating shelf allocation information.

13. A non-transitory computer-readable recording medium that records a program for causing a computer to execute:
when a change in display state of a product on a product shelf is detected, determining whether the change in display state is a change made by a store clerk; and
when the change in display state is a change made by the store clerk, generating shelf allocation information.
